(19) United States
(12) Patent Application Publication
(10) Pub. No.: US 2017/0252768 A1
(43) Pub. Date: Sep. 7, 2017

(54) CONTAINER STRUCTURE FOR FLOATING TYPE HUMIDIFIER

(71) Applicant: KPC Co., Ltd., Incheon (KR)

(72) Inventor: Yong Ju OH, Incheon (KR)

(21) Appl. No.: 15/511,447

(22) PCT Filed: Sep. 14, 2015
(86) PCT No.: PCT/KR2015/009606

§ 371 Date: Mar. 15, 2017

(30) Foreign Application Priority Data
Sep. 15, 2014 (KR) 10-2014-0122309

(51) Int. Cl. B05B 17/06; B01F 3/04; F24F 6/12

(52) U.S. Cl. CPC B05B 17/0615; F24F 6/12; B01F 3/0407

(57) ABSTRACT

A container structure for a floating type humidifier according to the present disclosure, in which the floating type humidifier is installed to be movable in a state in which the floating type humidifier floats on water stored in an accommodating space, includes: a lower body which has therein the accommodating space opened at an upper side thereof, and has a lower surface that is horizontally formed and seated on an installation surface; and an upper body which has a lower end that is correspondingly coupled to an upper end of the lower body, and an upper end that is formed to be bent toward the accommodating space so as to have a curved surface, and allows water flowing in a lateral direction by external force to flow back into the accommodating space.

### TECHNICAL FIELD

The present disclosure relates to a container structure for a floating type humidifier, and more particularly, to a container structure for a floating type humidifier in which a container may be seated on a wide area on an installation surface, and water flowing by external force does not overflow to the outside of the container, but flows back into an accommodating space, thereby ensuring both installation stability and safety of use.

### BACKGROUND ART

In general, a humidifier is a device for providing moisture into a dry room, and the humidifier is classified into an ultrasonic humidifier using ultrasonic waves and a heating humidifier using a heater based on a method of increasing humidity.

First, the ultrasonic humidifier converts water into fine water droplets by using an ultrasonic vibrator installed in a reservoir, and sprays the fine water droplets in an atomized state by using a blower fan, but in contrast, the heating humidifier evaporates water by using heat of a heater installed in a reservoir, and sprays the vapor in an atomized state by using a blower fan.

The two types of humidifiers are used in a state of being installed on a stationary installation surface, and problems about a bacterial growth and cleaning are considered as great drawbacks, and to solve the drawbacks, a natural humidifier, which is comparatively convenient to manage and clean, is widely used.

Among the natural humidifiers, a floating type humidifier, which is comparatively convenient to manage and clean, is widely used, and the floating type humidifier is characterized by being installed to be movable in a state in which the floating type humidifier floats on the water accommodated in a reservoir.

The floating type humidifier in the related art converts water, which flows into the floating type humidifier, into fine water particles by using an ultrasonic vibrator while floating in the reservoir at a predetermined height, and discharges the water particles in an atomized state by using a blower fan.

Further, the floating type humidifier in the related art is classified into a wireless humidifier which is supplied with electric power from a battery, and a wired humidifier which uses a power line in order to supply electric power to an ultrasonic vibrator in a state in which the wired humidifier is connected to a power supply unit.

However, in a case in which the wired floating type humidifier using the power line in the related art is used, the power line is not fixedly positioned, and as a result, there is concern that the floating type humidifier may be moved due to a movement of the power line or may collide with a wall surface of the reservoir.

Further, there is concern that the reservoir and the floating type humidifier may be damaged when the reservoir, which allows the floating type humidifier to float, may fall over or move by external force, and there is concern that water stored in the reservoir may overflow to the outside of the reservoir, which may cause an electric shock accident due to electric leakage.

As literature associated with the present disclosure, there is Korean Patent No. 10-1374967 (Mar. 10, 2014) that discloses a floating type humidifier.

### DISCLOSURE

### Technical Problem

An object of the present disclosure is to provide a container structure for a floating type humidifier in which a container is seated on a wide area on an installation surface, and water flowing by external force does not overflow to the outside of the container, but flows back into an accommodating space, such that it is possible to ensure installation stability because the container does not easily fall over by external force, and it is possible to ensure safety of use because it is possible to prevent an electric shock accident due to electric leakage.

Another object of the present disclosure is to provide a container structure for a floating type humidifier in which a power line of a floating type humidifier may be fixedly positioned, and as a result, it is possible to prevent the floating type humidifier from being moved by a movement of the power line, and thus to prevent the floating type humidifier and the container from being damaged due to a collision between the floating type humidifier and the container.

### Technical Solution

A container structure for a floating type humidifier according to the present disclosure, in which the floating type humidifier is installed to be movable in a state in which the floating type humidifier floats on water stored in an accommodating space, includes: a lower body which has therein the accommodating space opened at an upper side thereof, and has a lower surface that is horizontally formed and seated on an installation surface; and an upper body which has a lower end that is correspondingly coupled to an upper end of the lower body, and an upper end that is formed to be bent toward the accommodating space so as to have a curved surface, and allows water flowing in a lateral direction by external force to flow back into the accommodating space.

Here, the upper end of the lower body may have a width that is gradually increased upward, such that a lateral side of the lower body is formed to be inclined.

In addition, an opened upper portion of the upper body may have a diameter that is gradually decreased in a direction toward a center of the accommodating space.

In addition, rim portions of the lower surface and the upper end of the lower body may be formed to have a curved surface which is outwardly convex in order to disperse upward a horizontal load which occurs due to a horizontal movement of water.

In addition, an anti-slip member, which increases frictional force with the installation surface, may be further coupled to the lower surface of the lower body.

In addition, a plurality of convex portions or grooves may be formed at a lower end of the anti-slip member.

In addition, the upper end of the lower body and the lower end of the upper body may be coupled to each other by any one of a threaded connection method implemented by a horizontal rotation, an ultrasonic welding method, an adhesive attachment method, and a double injection molding method.

In addition, a handle, which is held by hand, may be further formed at one surface of the upper body.

In addition, a concave insertion groove may be further formed at the upper end of the upper body so that a power line of the floating type humidifier is mounted in the insertion groove.

In addition, a shock absorbing member, which absorbs shock at the time of a collision of the floating type humidifier, may be further coupled to an inner circumferential surface of the upper body.

### Advantageous Effects

According to the present disclosure, the container is formed to have a wide lower surface such that the container may be seated on the installation surface with high close contact force, and water flowing by external force does not overflow to the outside, but flows back into the accommodating space, such that it is possible to ensure installation stability because the container does not easily fall over by external force, and it is possible to ensure safety of use because it is possible to prevent an electric shock accident due to electric leakage.

In addition, the power line of the floating type humidifier may be fixedly positioned, and as a result, it is possible to prevent the floating type humidifier from being moved by a movement of the power line, and thus to prevent the floating type humidifier and the container from being damaged due to a collision between the floating type humidifier and the container.

### DESCRIPTION OF DRAWINGS

FIG. 1 is a cross-sectional front view illustrating a container structure for a floating type humidifier according to the present disclosure;

FIG. 2 is a cross-sectional front view illustrating a state in which an insertion groove is formed in an upper body of the container structure for a floating type humidifier according to the present disclosure;

FIG. 3 is a cross-sectional front view illustrating a state in which a shock absorbing member is applied to an inner circumference of the upper body of the container structure for a floating type humidifier according to the present disclosure; and

FIG. 4 is a cross-sectional front view illustrating a state in which a handle is applied to a lower body of the container structure for a floating type humidifier according to the present disclosure.

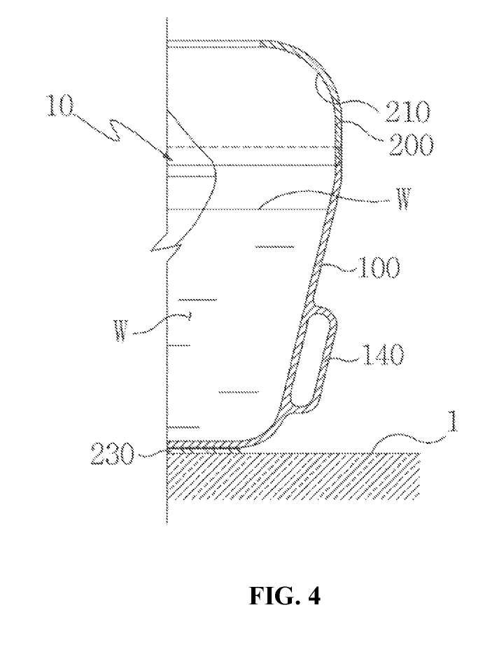

### DESCRIPTION OF MAIN REFERENCE NUMERALS OF DRAWINGS

| | |
|---|---|
| 1: Installation surface | 10: floating type humidifier |
| 11: Power line | 100: Lower body |
| 110: Accommodating space | 120: Lower surface |
| 130: Anti-slip member | 131: Groove |
| 140: Handle | 200: Upper body |
| 210: Guide surface | 220: Insertion groove |
| 230: Shock absorbing member | S: Accommodating space |
| W: Water | B: Adhesive |

### Best Mode

Hereinafter, exemplary embodiments of the present disclosure will be described in detail with reference to the accompanying drawings.

Advantages and features of the present disclosure and methods of achieving the advantages and features will be clear with reference to exemplary embodiments described in detail below together with the accompanying drawings.

However, the present disclosure is not limited to exemplary embodiment disclosed herein but will be implemented in various forms. The exemplary embodiments are provided so that the present disclosure is completely disclosed, and a person of ordinary skilled in the art can fully understand the scope of the present disclosure. Therefore, the present disclosure will be defined only by the scope of the appended claims.

In addition, in the description of the present disclosure, a detailed explanation of publicly known related technologies may be omitted so as to avoid unnecessarily obscuring the subject matter of the present disclosure.

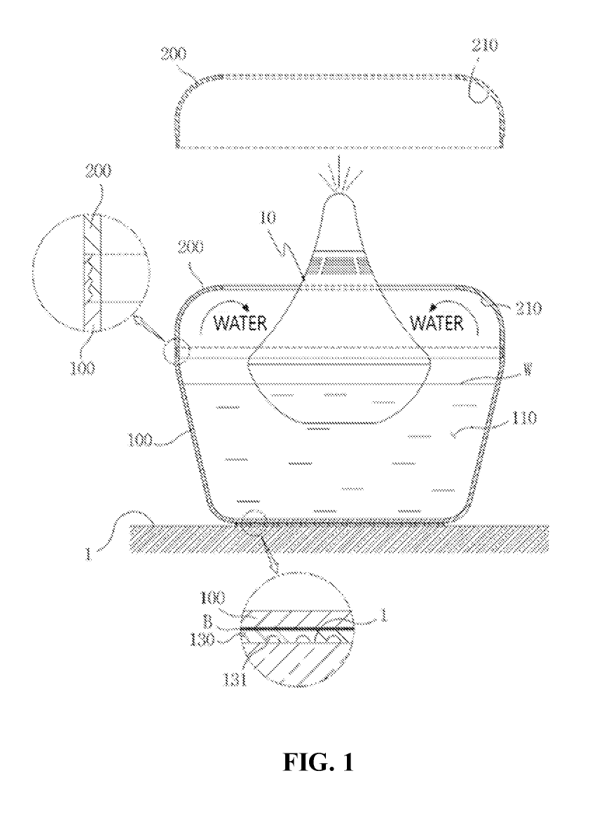

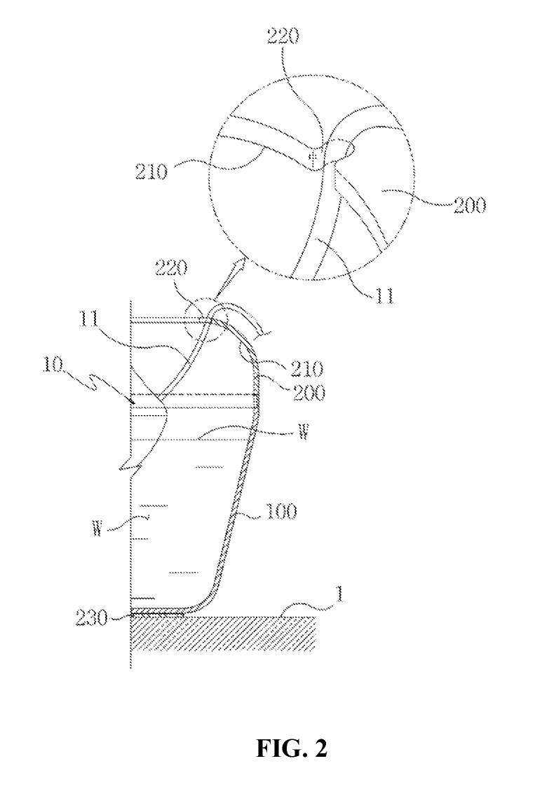

FIG. 1 is a cross-sectional front view illustrating a container structure for a floating type humidifier according to the present disclosure, and FIG. 2 is a cross-sectional front view illustrating a state in which an insertion groove is formed in an upper body of the container structure for a floating type humidifier according to the present disclosure.

Referring to FIGS. 1 and 2, in the container structure for a floating type humidifier according to the present disclosure, a floating type humidifier 20 is installed to be movable in an accommodating space 110 in a state in which the floating type humidifier 20 floats on water.

In particular, the container structure for a floating type humidifier according to the present disclosure may be divided into a lower body 100 and an upper body 200.

First, the lower body 100 has an accommodating space 110 for accommodating water therein, and has a lower surface 120 which is horizontally formed and seated on an installation surface (a floor of a room, a table, etc.) 1.

Here, the lower body 100 may have a shape having a width that is gradually increased upward from a lower end to an upper end.

In this case, a lateral side of the lower body 100 may be formed to be inclined so that a load of water, which is applied in a horizontal direction, is not applied in an orthogonal direction.

Further, as illustrated in FIG. 1, the lower body 100 may be manufactured in a cylindrical shape opened at an upper side thereof, but the lower body 100 may be manufactured in various shapes such as quadrangular, polygonal, and elliptical shapes.

In addition, the lower body 100 may be made of a material such as synthetic resin and metal, but the lower body 100 may be made by selectively using various materials that may accommodate water.

Further, the lower body 100 may be made of a transparent or semi-transparent material in order to observe, with the naked eye from the outside, a state in which the floating type humidifier 10 floats on water, or various pictures, colors, or the like may be displayed on the lower body 100 in order to emphasize an aesthetic appearance.

Furthermore, rim portions of the lower surface and the upper end of the lower body 100 may be formed to have a curved surface which is outwardly convex in order to disperse upward a horizontal load which occurs due to a horizontal movement of water.

That is, the rim portions of the lower surface and the upper end of the lower body 100 are connected through the curved surface, and as a result, a load of water flowing in a lateral direction may be dispersed upward along the lateral side of the lower body 100.

In addition, the lower surface 120 of the lower body 100 is in close contact with a wide area of the installation surface 1, and as a result, the lower body 100 does not easily move or fall over due to a flow of water.

In particular, as illustrated in FIGS. 1 and 2, an anti-slip member 130, which increases frictional force with the installation surface 1 and has a predetermined thickness, may be further coupled to the lower surface 120 of the lower body 100.

The anti-slip member 130 may be made of a material such as rubber and synthetic resin, but any material may be used as long as the material may prevent a slip.

Here, an upper end of the anti-slip member 130 and the lower surface 120 of the lower body 100 may be attached by using an adhesive B.

Otherwise, the anti-slip member 130 and the lower surface 120 of the lower body 100 may be penetratively coupled by using a separate fastening member (not illustrated).

Further, a plurality of convex portions or grooves 131 may be formed at a lower end of the anti-slip member 130.

For example, in a case in which the grooves 131 are formed at the lower end of the anti-slip member 130, predetermined adsorptive force is formed between the lower end of the anti-slip member 130 and the installation surface 1, and as a result, it is possible to ensure installation stability of the lower body 100.

In addition, the anti-slip member 130 may also serve to absorb shock applied to the lower surface 120 of the lower body 100 when the lower body 100 is installed on the installation surface 1.

Further, a loop-shaped handle 140 may be further formed on one surface of the upper body 200 so that a user may hold the handle.

The handle 140 may protrude in a loop shape from the lateral side of the upper body 200 so that the user may hold the handle 140, or the handle may be formed to be inserted into the upper body 200 so as not to protrude from a wall surface of the upper body 200.

The handle 140 may be formed integrally with the upper body 200 by using the same material as the upper body 200, or the handle 140 and the upper body 200 may be coupled to each other by using a separate fastening member (not illustrated).

That is, the user may easily move a position of the container by holding the handle 140.

A center of the upper body 200 is formed to be penetrated in a vertical direction, and a lower end of the upper body 200 is correspondingly coupled to the upper end of the lower body 100.

The upper body 200 prevents water accommodated in the accommodating space 110 of the lower body 100 from overflowing to the outside when the water flows in the lateral direction by external force.

To this end, the upper body 200 has a shape such that the upper end of the upper body 200 is bent to have a curved surface toward the accommodating space 110 while extending upward.

Here, an upper opening portion of the upper body 200 may have a diameter that is gradually decreased in a direction toward a center of the accommodating space 110.

Further, the lower end of the upper body 200 and the upper end of the lower body 100 may be coupled to each other by any one of a threaded connection method implemented by a horizontal rotation, an ultrasonic welding method, an adhesive attachment method, and a double injection molding method.

Of course, the lower end of the upper body 200 and the upper end of the lower body 100 may be coupled to each other by various coupling methods other than the aforementioned methods.

For example, in a case in which the upper body 200 and the lower body 100 are intended to be correspondingly coupled to each other by the threaded connection method, corresponding end portions of the upper body 200 and the lower body 100 may have a cylindrical shape.

A guide surface 210 guides the water which flows in the lateral direction of the accommodating space 110 by external force so that the water flows back into the accommodating space 110 while flowing upward.

When the water stored in the accommodating space 110 flows in the lateral direction by external force, the shape of the upper body 200 allows the water to flow back into the accommodating space 110 while flowing upward through an inner circumferential surface of the lower body 100 and the guide surface 210.

Therefore, according to the present disclosure, it is possible to prevent the water stored in the accommodating space 110 from easily overflowing to the outside by external force, and thus to prevent an electric shock accident due to electric leakage, thereby enabling the user to more safely use the floating type humidifier 10.

For example, families with young children or pets will require the water overflowing prevention structure according to the present disclosure, and the water overflowing prevention structure will be more effective when used in the earthquake affected areas such as Japan.

Meanwhile, as illustrated in FIG. 2, an insertion groove 220 may be further formed concavely at the upper end of the upper body 200 so that a power line 11 of the floating type humidifier 10 may be mounted in the insertion groove 220.

The insertion groove 220 may have a circular shape, an elliptical shape, and the like that corresponds to an outer circumference of the power line 11, but the shape of the insertion groove 220 may vary depending on a shape of the power line 11.

Here, an opened upper inlet portion of the insertion groove 220 may be formed to have a smaller width than a lower portion of the insertion groove 220. In this case, the power line 11 inserted and mounted in the insertion groove 220 may be fixedly pressed and supported without being withdrawn from the upper portion of the insertion groove 120.

Further, a plurality of insertion grooves 220 may be formed, and a position of the insertion groove 220 may also be variously changed.

Therefore, since the power line 11 of the floating type humidifier 10 is fixedly positioned by using the insertion groove 220, the power line 11 of the floating type humidifier 10 is not easily moved by external force.

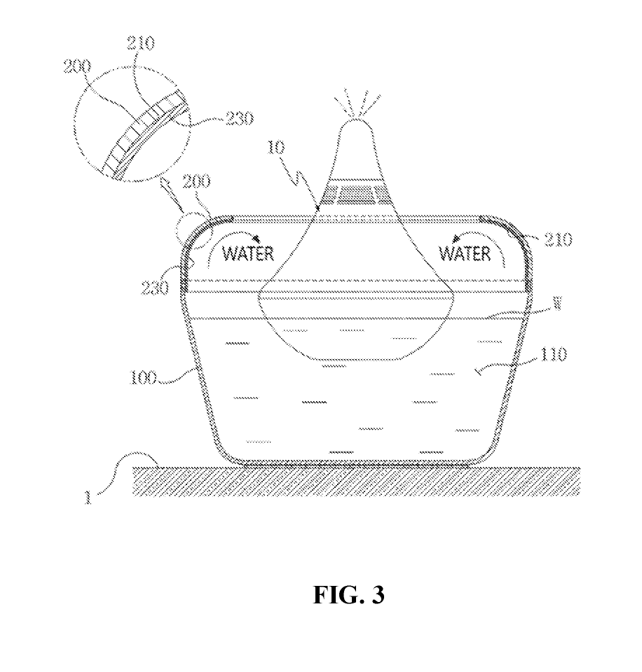

Meanwhile, as illustrated in FIG. 3, a shock absorbing member 230, which absorbs shock at the time of a collision of the floating type humidifier 10, may be further coupled to an inner circumferential surface of the upper body 200.

The shock absorbing member 230 may have a shape corresponding to the guide surface 210, and may be attached to the guide surface 210, and the shock absorbing member 230 may be made of a material such as rubber, synthetic resin, or sponge which is strong against moisture.

Here, the shock absorbing member 230 may be correspondingly attached to the guide surface 210 by a separate adhesive.

The shock absorbing member 230 may absorb shock when the floating type humidifier 10 floating on the water moves by a flow of the water and then collides with the upper body 200, thereby preventing damage to the floating type humidifier 10 and the upper body 200.

Consequently, according to the present disclosure, the lower body 100 may be seated on the installation surface 1 with high close contact force, and the water flowing by external force does not overflow to the outside of the container, but may flow back into the accommodating space 110.

Therefore, it is possible to ensure installation stability because the water does not easily overflow by external force, and it is possible to ensure safety of use because it is possible to prevent an electric shock accident due to electric leakage that may occur when the water overflows.

In addition, since it is possible to fixedly position the power line 11 of the floating type humidifier, it is possible to prevent the floating type humidifier 10 from being moved by a movement of the power line 11, and as a result, it is possible to prevent damage to the floating type humidifier 10, the lower body 100, and upper body 200 due to a collision.

While the specific exemplary embodiments related with the container structure for a floating type humidifier according to the present disclosure have been described above, the exemplary embodiments may be modified to various exemplary embodiments without departing from the scope of the present disclosure.

Therefore, the scope of the present disclosure should not be limited to the described exemplary embodiment, but should be defined by the appended claims and the equivalents of the claims.

Accordingly, it should be understood that the aforementioned exemplary embodiment is described for illustration in all aspects and is not limited, and the scope of the present disclosure shall be represented by the claims to be described below, instead of the detailed description, and it should be construed that all of the changes or modified forms induced from the meaning and the scope of the claims, and an equivalent concept thereto are included in the scope of the present disclosure.

1. A container structure for a floating type humidifier in which the floating type humidifier is installed to be movable in a state in which the floating type humidifier floats on water stored in an accommodating space, the container structure comprising:
a lower body which has therein the accommodating space opened at an upper side thereof, and has a lower surface that is horizontally formed and seated on an installation surface; and
an upper body which has a lower end that is correspondingly coupled to an upper end of the lower body, and an upper end that is formed to be bent toward the accommodating space so as to have a curved surface, and allows water flowing in a lateral direction by external force to flow back into the accommodating space.

2. The container structure according to claim 1, wherein the upper end of the lower body has a width that is gradually increased upward, such that a lateral side of the lower body is formed to be inclined.

3. The container structure according to claim 1, wherein an opened upper portion of the upper body has a diameter that is gradually decreased in a direction toward a center of the accommodating space.

4. The container structure according to claim 1, wherein rim portions of the lower surface and the upper end of the lower body are formed to have a curved surface which is outwardly convex in order to disperse upward a horizontal load which occurs due to a horizontal movement of water.

5. The container structure according to claim 1, wherein an anti-slip member, which increases frictional force with the installation surface, is further coupled to the lower surface of the lower body.

6. The container structure according to claim 5, wherein a plurality of convex portions or grooves is formed at a lower end of the anti-slip member.

7. The container structure according to claim 1, wherein the upper end of the lower body and the lower end of the upper body are coupled to each other by any one of a threaded connection method implemented by a horizontal rotation, an ultrasonic welding method, an adhesive attachment method, and a double injection molding method.

8. The container structure according to claim 1, wherein a handle, which is held by hand, is further formed at one surface of the upper body.

9. The container structure according to claim 1, wherein a concave insertion groove is further formed at the upper end of the upper body so that a power line of the floating type humidifier is mounted in the insertion groove.

10. The container structure according to claim 1, wherein a shock absorbing member, which absorbs shock at the time of a collision of the floating type humidifier, is further coupled to an inner circumferential surface of the upper body.
